(19) United States
(12) Patent Application Publication
(10) Pub. No.: US 2003/0229824 A1
(43) Pub. Date: Dec. 11, 2003

(54) Device for semiconductor memory repair

(76) Inventor: William K. Waller, Eagle, ID (US)

Correspondence Address: William K. Waller, 2262 N. Greenview Court, Eagle, ID, 83616, US

(21) Appl. No.: 10/166,499

(22) Filed: Jun. 11, 2002

(51) Int. Cl. H04B 1/74

(52) U.S. Cl. 714/30

(57) ABSTRACT

The current invention discloses a circuit design to detect whether an address on an address bus matches the state of a group of fuses which may have been blown in the process of permanently programming redundant circuitry used for integrated circuit repair. The fuse detection circuit provides a new combination of optimized speed, improved soft error immunity, reduced address line loading, and smaller device size.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention relates to semiconductor memory devices, and specifically to repair technology used to improve manufacturing yield for high-capacity devices.

Integrated circuit repair techniques are well known in the manufacture of high-capacity memory devices. Repair is required to maintain viable manufacturing yield, as memory devices have become so large that manufacturing defects cannot be avoided.

On an integrated circuit, repair is done by identifying a defective portion of the device through stressing and testing procedures, then disabling each defective portion and enabling a replacement circuit which has been included in the design for this purpose. The replacement circuit is permanently programmed to respond to the same set of signals as the defective portion it replaces. The permanent programming may be done by selectively blowing fuses or anti-fuses, or altering the state of nonvolatile semiconductor memory, within the replacement circuit.

Circuit size, speed, power consumption and reliability are ever important design issues in integrated circuit devices. Size is especially important as the number of replacement circuits included on a device affects device memory capacity, and also sets the maximum number of defective circuits that may be repaired before scrapping a device as non-functional. Speed is important as the decision between using original or replacement circuitry must be made in every memory access.

FIG. 1 shows a prior-art fuse detection circuit as disclosed by U.S. Pat. No. 5,838,620, issued Nov. 17, 1998 to Zagar and Ong. The same circuit appears as FIG. 80D in U.S. Pat. No. 6,324,088, issued Nov. 27, 2001 to Keeth, et al. In FIG. 1, a transistor 146 is activated to sample the state of fuse 138. When activated, transistor 146 attempts to pull high the voltage on a node 140. If the fuse is blown, its high-resistance state permits transistor 146 to pull node 140 high. If the fuse is intact, its low resistance to ground holds node 140 low. A transistor 142 is present to limit crossing-current between the power rails when sampling an intact fuse. Transistor 142 is always on, due to the coupling of a gate contact of this transistor to ground, and serves to provide a fixed resistance in the circuit. However, when the fuse is intact, the parasitic source and drain capacitances of transistor 142 will be discharged to ground by the fuse. When sampling the fuse, transistor 142 will delay the pullup sampling process by a time substantially equivalent to the RC time constant imposed by the resistance and capacitance of transistor 142. A disadvantage in the design of FIG. 1 is that transistor 142 delays the sampling unnecessarily because it is precharged low by the fuse. A further disadvantage occurs due to the delay imposed by switching the impedance of transistor 142: during this delay, the input voltage to the inverter is moving between its low and high values in the usual case when the fuse has not been blown. The inverter in this condition draws a useless ‘crossing current’ directly from the positive supply to ground, wasting power. The additional power consumption due to the switching delay as described is a disadvantage in the FIG. 1 design.

Also in FIG. 1, when sampling a blown fuse, output node 150 goes low. The low level on node 150 activates a transistor 144 to latch node 140 high. To end the sampling interval, transistor 146 will be turned off, and transistor 144 continues to hold node 140 high when the fuse is blown. But transistor 142 forms part of this latching feedback loop when the fuse is blown. A second disadvantage in the design of FIG. 1 is that the impedance of transistor 142 weakens the feedback latching provided by transistor 144, providing less protection against soft errors such as single-event upset caused by alpha particle radiation, than would be the case if transistor 142 were not in the feedback loop.

FIG. 2 shows a prior-art fuse detection circuit as disclosed in U.S. Pat. No. 5,812,470, issued Sep. 22, 1998 to Ochoa, et al. In FIG. 2, a transistor 202 is always active because a gate contact of this transistor is grounded. To sample the state of a fuse 210, an input EN* is driven low to activate a transistor 204 and a transistor 208. An intact fuse will hold node 206 low during sampling, but a blown fuse will permit node 206 to pull high.

The circuit of FIG. 2 has a problem when the fuse 210 is not blown. In this event, when sampling the fuse, the low level on node 206 is inverted to drive node 220 high, cutting off transistor 212. Normal operation will then stop sampling in order to turn off sense current, which is not needed after fuse state has been detected. To end sampling, input EN* goes high and stays high, cutting off transistors 204 and 208, making node 206 a “floating” node. At this point, no active component holds node 206 at a known logic level, so the voltage on node 206 can float high, intermediate, or low, depending on leakage currents of the turned-off transistors 204, 208, and 212. If the voltage on node 206 should become higher than the switchpoint of inverter 214, output node 220 would be driven low in error, and the output 220 would be latched in that erroneous state because transistor 212 would be activated by the low voltage on node 220. When transistor 212 is activated, node 206 is held high by transistor 212 to accomplish the latching. A disadvantage of the FIG. 2 design is that reliable operation is not assured due to floating node 206.

FIG. 3 shows a prior-art fuse detection circuit as disclosed in U.S. Pat. No. 6,333,887, issued Dec. 25, 2001 to Vo. In FIG. 3, the state of the fuse 308 is sampled when an input RDFUS* is driven low to activate a transistor 300, pulling up node 306 when the fuse is blown, and failing to pull up node 306 when the fuse 308 is intact. When the fuse 308 is blown, a high level on node 306 is inverted to drive a low level on node 310, turning on transistor 304 to latch the low output on node 310 by holding node 306 high. However, the feedback loop which latches node 306 high is weakened by including transistor 302 in the pullup path for the loop. In the event of a transient electrical charge produced by an ionizing event anywhere in node 306, the resistance of transistor 302 causes a transient voltage response in node 306. In the process of removing the transient electrical charge, it is the IR voltage drop in the resistance of transistor 302 that causes the voltage transient. A ‘soft error’ would occur if this transient voltage should flip the state of output node 310 any time after sampling the fuse 308. The design of FIG. 3 has the disadvantage of greater susceptibility to soft errors due to the presence of transistor 302.

FIG. 4 shows a prior-art fuse detection set as disclosed in U.S. Pat. No. 6,314,032, issued Nov. 6, 2001 to Takase. FIG. 4 plainly shows one comparator circuit CMP for each fuse in the set of address lines. A disadvantage of the FIG. 4 design, and of all prior circuits, is their one-to-one relationship of comparators to address-line fuses. The multiplicity of comparators results in unduly large device size and address-line capacitive loading.

### BRIEF SUMMARY OF THE INVENTION

A fuse is a two-terminal electrical device which normally has a low-impedance connection between its terminals. The fuse may be electrically programmed, or ‘blown’ so that it is permanently altered to have a high impedance or open circuit between its terminals.

The current invention is directed to devices used to detect the state of fuses which may have been blown in the process of permanently programming portions of an integrated circuit device. An object of the current invention is to implement the fuse detection logic in smaller circuits, with optimized speed and reliability. A device of the current invention detects the state of a fuse and latches an internal signal node indicating the state of the fuse.

The device of the current invention solves the disadvantages of the design of FIG. 1 by providing better speed, because the parasitic capacitance of the current-limiting transistor in the current invention is not switched high and low in every fuse-detect cycle.

The device of the current invention solves the disadvantages of the design of FIG. 2 by providing a device that actually works, and by using fewer transistors.

The device of the current invention solves the disadvantages of the design of FIGS. 1 and 3 by providing a design with improved reliability against soft errors via a low impedance feedback loop that is more robust in reacting to the disturbances that cause soft errors. Soft errors are correctible erroneous data within a memory, usually caused by charge liberated by an environmental alpha particle passing through the device, or by electrical noise in the device.

The device of the current invention solves the disadvantages the design of FIGS. 1, 2, 3, and 4, by providing circuitry to select which fuse detection circuit connects to the comparator for deciding whether to use redundant circuitry on a given address. Prior-art methods use one comparator to evaluate every fuse-signal/address-signal combination. However not all of the redundant elements can be used in each memory access: typically 75 percent of the redundant elements cannot be used in a particular memory cycle. In the current invention, fuse signals are multiplexed such that only those fuse signals actually used in a particular memory cycle are coupled to the comparators. The current invention only includes the number of comparators needed in any particular memory cycle. The current invention thus reduces the number of comparators needed, requiring less device area than prior art, and al less capacitive load on the address lines. The smaller load on address lines gives an advantage of better speed and less power consumption.

### BRIEF DESCRIPTION OF THE SEVERAL VIEWS OF THE DRAWING

FIGS. 1-3 show prior-art fuse detection circuits.

FIG. 4 shows a prior-art relationship of comparators to fuse detection devices, and a prior-art fuse detection circuit.

FIG. 5 illustrates a preferred fuse detection device of the current invention.

FIG. 6 is a block-level diagram describing the method of the current invention.

FIG. 7 discloses detailed circuitry implementing the method of the current invention.

FIG. 8 shows an alternate possible implementation of the method of the current invention.

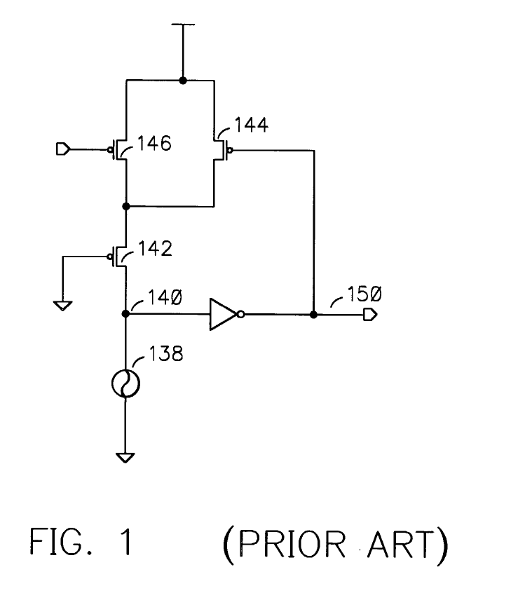

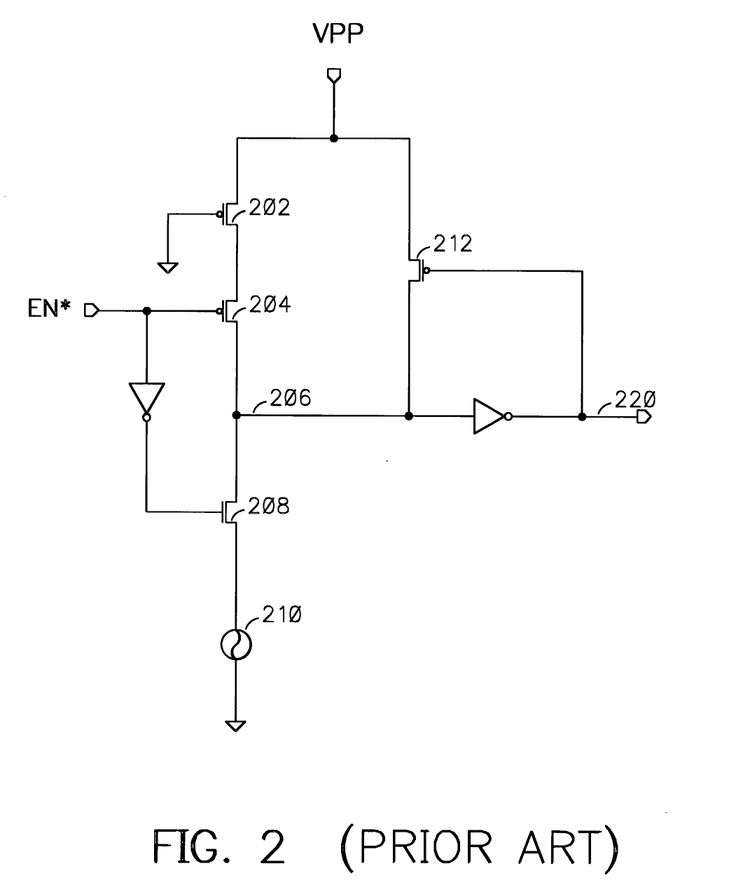

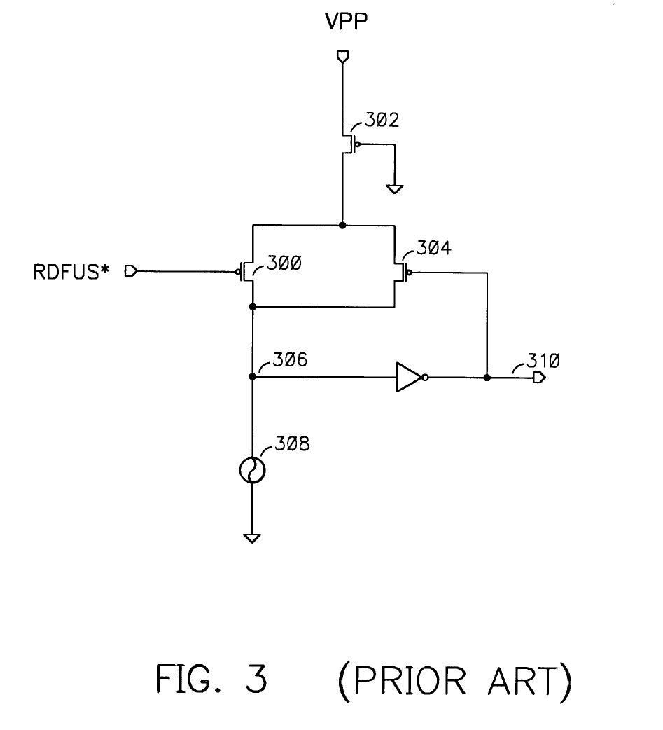

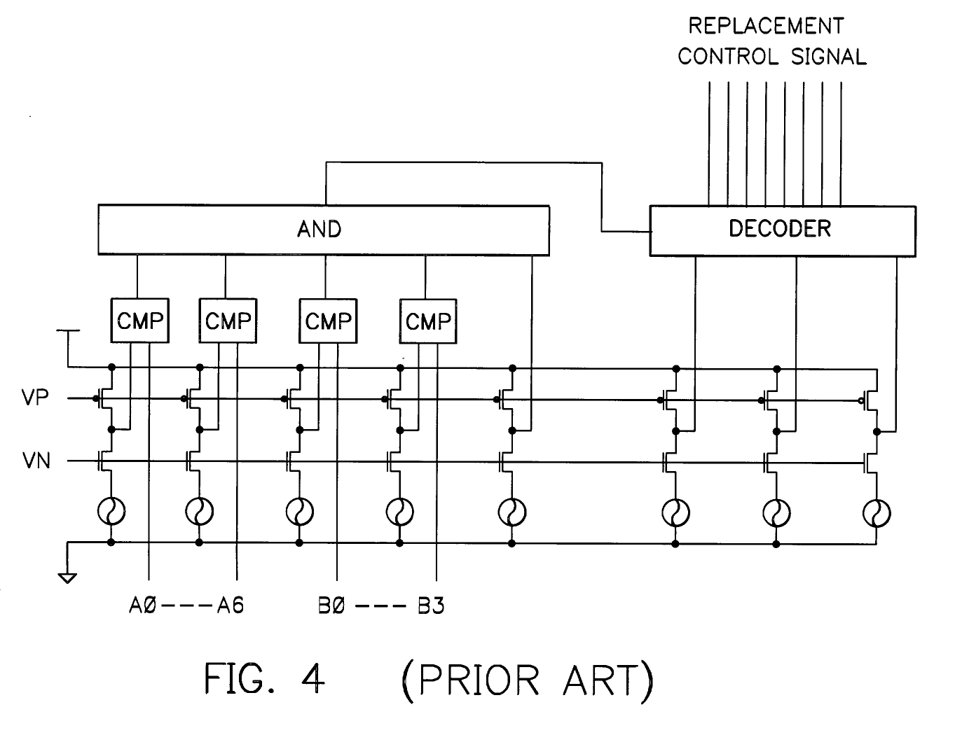

### DETAILED DESCRIPTION OF THE INVENTION

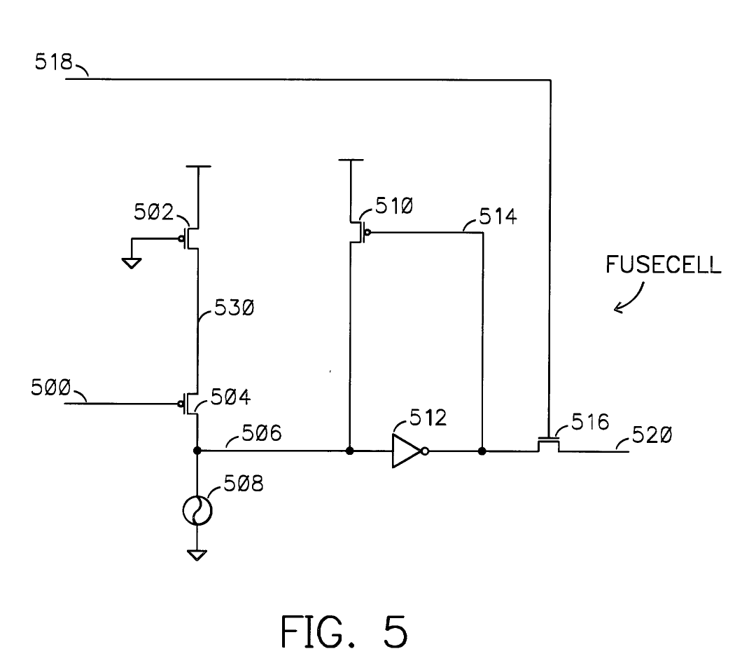

FIG. 5 shows a preferred embodiment of a device of the current invention. In FIG. 5, a fuse 508 couples between a ground voltage supply and a control node 506. If the fuse is intact, it will connect node 506 directly to ground through a low-impedance connection. If the fuse has been blown, the fuse will form a high-impedance connection between node 506 and ground. The drain contact of a sampling transistor 504 couples to control node 506. The gate contact of transistor 504 couples to input 500. The source contact of transistor 504 couples to node 530. Transistor 504 is a sampling device that switches the fusecell circuit into a sampling state when activated by a logic low signal on gate node 500, and into a holding state when turned off by a logic high signal on gate note 500. Node 530 couples to the drain contact of a power-limiting device, transistor 502. The gate contact of transistor 502 couples to the ground voltage supply. The source contact of transistor 502 couples to the positive voltage supply. Transistor 502 is always activated, because its gate is tied logically low, and serves as a fixed resistance to limit the flow of current and hence power during the sampling process. Because transistor 502 has its source and drain always logically high, transistor 502 never imposes a switching delay on circuit performance. Node 506 couples to the input of a signal amplifier, inverter 512. The output of inverter 512 couples to signal node 514, which is driven low when the fuse is blown, and high when the fuse is intact. The source contact of an isolation device, transistor 516, couples to signal node 514. The gate contact of transistor 516 couples to an ‘enable’ input signal 518. The drain contact of an enable transistor 516 couples to an output signal 520. Transistor 516 serves to couple the signal node 514 to output 520 when the enable input 520 is logically high, and to decouple or tristate output 520 when the enable input 520 is logically low. Transistor 516 is preferably a low-threshold transistor, but may also be an ordinary n-type transistor. Control node 514 also couples to a gate contact of feedback transistor 510. The source of transistor 510 couples to the positive voltage supply. The drain of transistor 510 couples to control node 506, forming a feedback loop which, when signal node 514 is low due to a blown fuse, holds control node 506 logically high after the sampling transistor turns off.

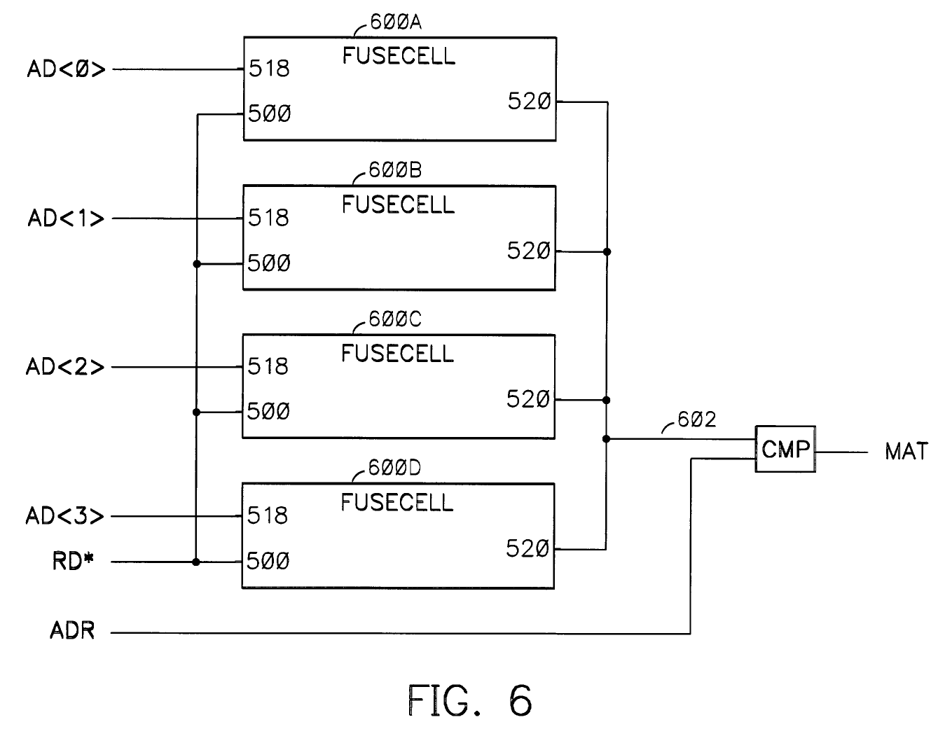

FIG. 6 is a block level diagram showing four instances of the circuit of FIG. 5 as blocks 600A-600D. The sampling input 500 of each instance couples to a common input RD*. The ‘enable’ input 518 of each instance couples to a separate pre-decoded address input AD<0> . . . AD<3>. Pre-decoded address inputs have been processed such that an address presented on a first pair of address lines, A<0>, A<1> (not shown) will activate exactly one of the lines in the set AD<0> AD<1> AD<2> AD<3>. Because only one address can be valid in any cycle, only one of the pre-decoded address inputs AD<0> . . . AD<3>can be active at any time. The arrangement shown will thus gate only one fusecell output to the comparator during each memory cycle, the one that is actually needed. The other fusecells, the ones that are not usable in the current cycle, will be effectively turned off because their output nodes will be tristated. The output 520 of each fusecell block couples to a common node 602. Node 602 couples to an input of comparator block CMP. A top level input ADR couples to a second input of comparator block CMP. An output of comparator CMP couples to an output signal MAT, the ‘match’ line.

The significance of this arrangement is that during any single memory access, only a fraction of the fusecell blocks can be utilized; this fraction can vary but it is typically 25% as shown in the example of FIG. 6. In the current invention, only the active fusecells for a given memory access are coupled to comparator inputs and the inactive fusecells are switched out by tristating their outputs. The arrangement of the current invention has the advantage of removing a substantial fraction of the comparators needed, fully 75% of them in the example of FIG. 6, to perform repair, thus reducing the memory device size.

The arrangement of the current invention has the further advantage of reducing the capacitive load on the address lines ADR, thus increasing the speed of every memory access, as follows. In FIG. 6, the prior art methods require four comparators, one for each fusecell block, and the ADR input had to connect to all four comparators, even though only one of them would be active in any cycle. The plurality of comparators attached to the address lines presented significant capacitive loads which are sharply reduced in the current invention. The ADR lines are heavily loaded lines, and they form part of the timing critical path for every memory access: before accessing the memory, the system must ask the fuse cells whether to use a redundant circuit for the access, only after getting an answer can the access proceed. By reducing the capacitive load on the ADR lines, the current invention permits the whole process to proceed more quickly.

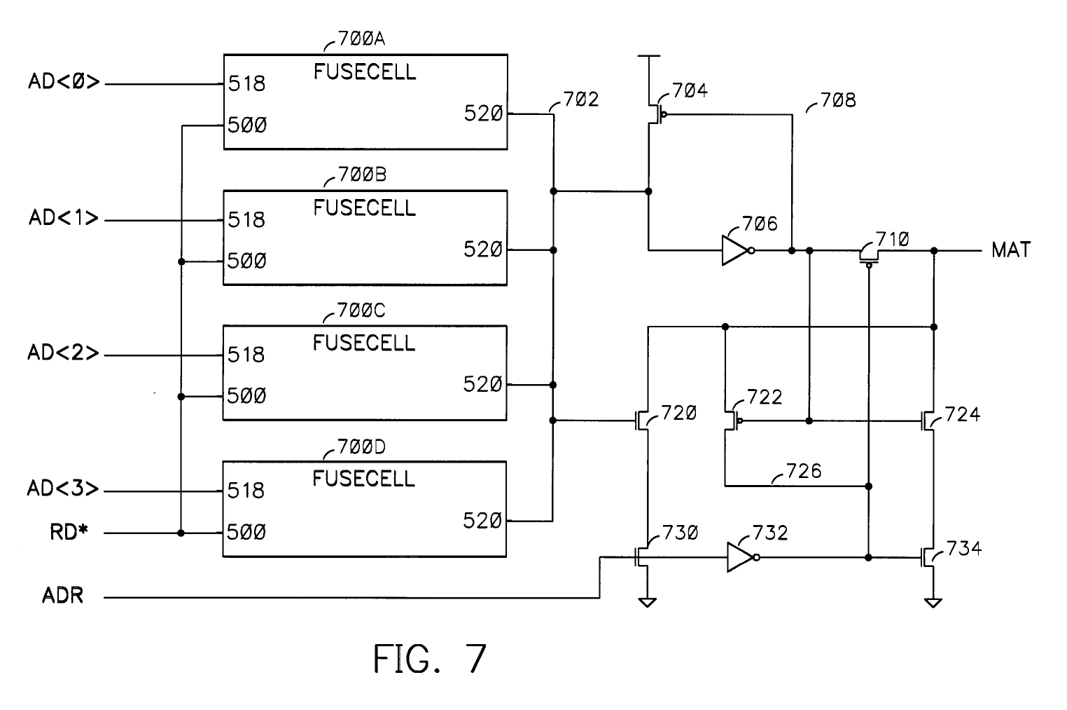

FIG. 7 shows four instances of the fusecell as blocks 700A-700D. An enable input 518 of each block couples to a separate pre-decoded address input bused as AD<0> . . . AD<3>. An output 520 of each block couples to a common fusecell output node 702. Node 702 couples to the input of an inverter 706. The output of inverter 706 couples to node 708. Node 708 couples to a gate contact of a feedback transistor 704, to the source contact of transistor 710, and to the gates of transistors 722 and 724. The drain contact of transistor 704 couples to node 702, and the source contact of transistor 704 couples to a positive voltage supply. Transistor 704 forms a ‘half latch’ feedback circuit which holds node 702 high when node 708 is low. The drain contact of transistor 710 couples to output node MAT. Node 702 couples to a gate of a transistor 720. The drain of transistor 720 couples to output node MAT. The source of transistor 720 couples to the drain of transistor 730. The gate of transistor 730 couples to input node ADR. The source of transistor 730 couples to the ground voltage supply. The input of inverter 732 couples to input node ADR. The output of inverter 732 couples to node 726. Node 726 couples to the gate of transistor 710, to the gate of transistor 734, and to the drain of transistor 722. The source contact of transistor 722 couples to output node MAT. Transistor 724 has its drain contact coupled to the output node MAT, and its source contact coupled to a drain contact of transistor 734. The source contact of transistor 734 is coupled to the ground voltage supply.

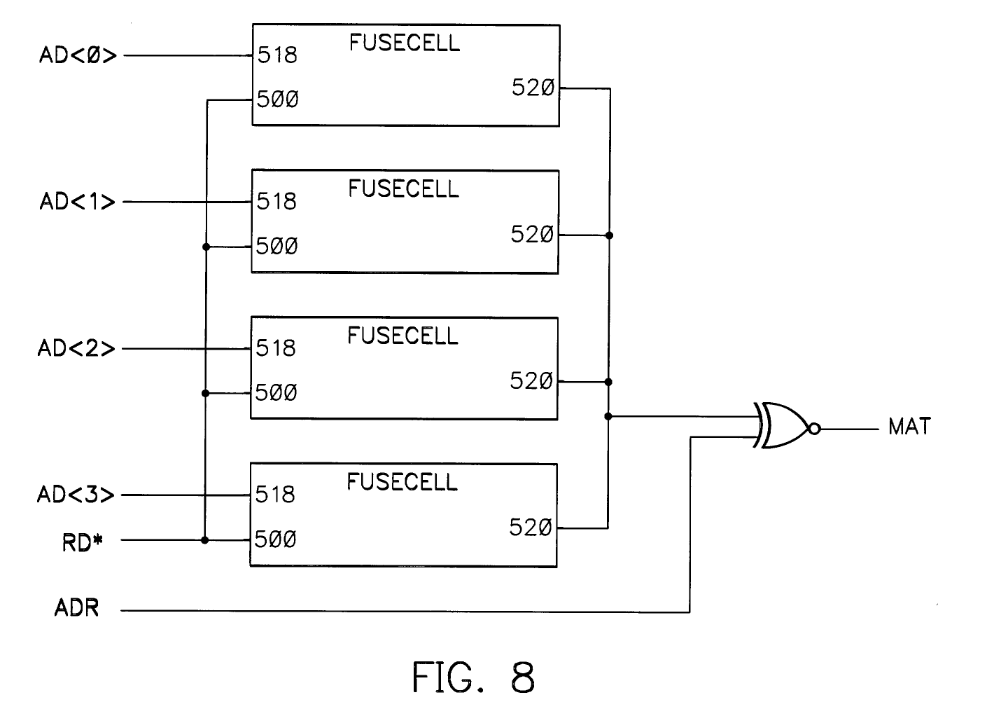

FIG. 8 shows an alternative embodiment with a design similar to FIGS. 6 and 7, in which the comparator function has been implemented in a generic exclusive-nor gate. Similar ramifications, such as replacing the exclusive-nor gate with an exclusive-or gate, or replacing the enable transistor within the fusecell with a full transmission-gate, or a somewhat different implementation of address predecoding, would fall within the scope of the current invention.

I claim:

1. A device for detecting and latching the state of a fuse, comprising:
a. a control node operable between one of two logical values,
b. a fuse coupled between the control node and a logical low signal,
c. means including a sampling device operable between an active and an inactive state, the sampling device being coupled between the control node and a first logical high signal, for
i. setting the control node logically high when the sampling device is active in response to an active logic state of a read input signal and the fuse has been programmed to a high impedance state, and
ii. setting the control node logically low when the sampling device is active in response to an active logic state of the read input signal and the fuse has not been programmed to a high impedance state, and
iii. cutting off power used for sampling when the sampling device is inactive in response to an inactive logic state of the read input signal,
d. means including a power-limiting device coupled between the first logical high signal and a second logical high signal, for preventing excessive power consumption when the sampling device is active,
e. means including an inverting signal amplifier for sensing the state of the control node and setting an internal signal node logically high when the control node is logically low, and setting the internal signal node logically low when the control node is logically high;
f. means including a feedback device coupled directly between the control node and the second logical high signal, the feedback device being activated by the internal signal node being in a logically low state, for holding the control node in a logically high state when the fuse has been programmed to a high impedance state;
the logic state of the internal signal node thus being controlled by the state of the control node, the state of the control node during and after activation of the sampling device being determined by the state of the fuse, the logic state of the internal signal node after activating the sampling device thus indicating the state of the fuse, the device of the current invention thereby providing a new combination of:
a. optimized speed, by holding the signal value in the power limiting device substantially at a logical high and thus avoiding delay due to switching the power limiting device between logic states, and
b. improved protection against soft errors, by using feedback with a minimum number of components and therefore lowest impedance in the feedback path, thus maximizing ability of the device to withstand electrical disturbances without erroneously changing state, and
c. functionality, by providing a device actively controlled in all possible states.

2. The device of claim 1, with means including an isolation device for:
a. coupling an output node to the internal signal node when an enable signal is logically active, and
b. decoupling the output node from the internal signal node and placing the output node in a high impedance state when the enable signal is logically inactive.

3. The device of claim 1, in which:
a. the sampling device comprises a transistor having a gate contact coupled to the read input signal, a source contact coupled to a first internal node, and a drain contact coupled to the control node,
b. the power-limiting device comprises a transistor having a gate contact coupled logically low, a source contact coupled to a chip positive supply voltage, and a drain contact coupled to the first internal node,
c. the signal amplifier comprises an inverter having an input coupled to the control node and an output coupled to the internal signal node,
d. the feedback device comprises a transistor having a gate contact coupled to the internal signal node, a source contact coupled to the chip positive supply voltage, and a drain contact coupled to the control node.

4. The device of claim 2, in which:
a. the sampling device comprises a transistor having a gate contact node coupled to the read signal, a source contact coupled to a first internal node, and a drain contact coupled to the control node,
b. the power-limiting device comprises a transistor having a gate contact coupled logically low, a source contact coupled logically high, and a drain contact coupled to the first internal node,
c. the signal amplifier comprises an inverter having an input coupled to the control node and an output coupled to the internal signal node,
d. the feedback device comprises a transistor having a gate contact coupled to the internal signal node, a source contact coupled logically high, and a drain contact coupled to the control node, and
e. the isolation device comprises a transistor having a gate contact coupled to the enable signal, a source contact coupled to the internal signal node, and a drain contact coupled to the output node.

6. A method for reducing the number of comparators required to compare the state of a plurality of fuses with the state of a plurality of address signals, comprising the steps of:
a. predecoding a set of low-order address signals such that an address asserted by the set of low-order address signals activates a separate decoded address signal, only one low-order address and one decoded address signal being active at any given time, and
b. supplying a plurality of fuse detection devices equal in number to the decoded address signals, each fuse detection device having a fuse which may be permanently programmed, each fuse detection device having an enable input node, each fuse detection device having a sample input node which, when driven logically active, causes the fuse detection device to sample the state of its fuse and to latch an internal signal node within the fuse detection device logically active when the fuse is intact, the internal signal node being latched logically inactive during the sampling of the state of the fuse when the fuse has been programmed, each fuse detection device having a single output node which is coupled to the internal signal node when the enable input node of the device is logically active, the output node of the fuse detection device being decoupled from the internal signal node by being set to a high impedance state when the enable input node of the device is logically inactive, and
c. coupling each decoded address signal to the enable input node of a separate fuse detection device, and
d. coupling the sample input node of each fuse detection device to a common read input signal node, so that the fuse detection devices may be made to sample and latch the states of their respective fuses essentially simultaneously, and
e. coupling together a plurality of output signals from all the fuse detection devices so employed, to form a single input to a comparator, contention between the outputs of the fuse detection devices being avoided by actively coupling to the single comparator input only an internal signal node within the single fuse detection device which has an active fusecell enable signal, all other fuse detection devices having inactive fusecell enable signals applied to their enable inputs, and thus having output signals decoupled by being placed in a high impedance state, and
f. coupling an address signal from a second set of high order address signals to a second input of the comparator, so that a signal on a match output node of the comparator indicates whether the fuse selected by the address on the low-order address lines is blown when the address signal from the set of high-order address signals is logically high, and also indicates whether the fuse selected by the address on the low-order address lines is intact when the address signal from the set of high-order address lines is logically low, and
g. repeating steps a. through e. above for each and every one of a plurality of addresses from the set of high-order address signals, so that there is a one-to-one relationship between the high-order address signals and comparator outputs, the comparator outputs, when logically active, indicating that either the associated high-order address signal is logically active, or the fuse associated with the low-order address signals is intact, but not both, and
h. using the totality of comparator output signals so generated to indicate a logical match between a set of programmed fuses and an address comprising address signals from both the high-order and the low-order sets of address signals.

7. A device for detecting and latching the state of a fuse, comprising:
a plurality of pre-decoded input address signals derived from a first set of address signals, the first set of address signals being pre-decoded such that exactly one pre-decoded input address signal is logically active for each valid address supplied by the first set of address signals;
an input read signal;
a second input address signal from a second set of address signals;
an output match signal;
power-supply connections comprising a chip supply voltage and a ground supply voltage;
the output match signal coupling to a drain contact of a first transistor, a gate contact of the first transistor coupling to a first internal node, a source contact of the first transistor coupling to a second internal node, the second internal node coupling to an output of a first inverter, the second internal node coupling to a gate contact of a second transistor, a gate contact of a third transistor, and a gate contact of a fourth transistor; a source contact of the second transistor coupling to the chip supply voltage, a drain contact of the second transistor coupling to a third internal node, the third internal node coupling to an input of the first inverter, the third internal node coupling to a gate contact of a fifth transistor, a drain contact of the fifth transistor coupling to the output match signal, a source contact of the fifth transistor coupling to a drain contact of a sixth transistor, a source contact of the sixth transistor coupling to the ground supply voltage, a gate contact of the sixth transistor coupling to a high order address input signal from a second set of address signals and to an input of a second inverter, an output of the second inverter coupling to the first internal node, the first internal node coupling to a source contact of the third transistor, the output match signal coupling to a drain contact of the third transistor, the first internal node coupling to a gate contact of a seventh transistor, a source contact of the seventh transistor coupling to the ground power supply, a drain contact of the seventh transistor coupling to a source contact of the fourth transistor, a drain contact of the seventh transistor coupled to the output match signal, the third internal node coupling to a plurality of output nodes of a plurality of fusecell instances of the device of claim 4, the input read signal coupling to a plurality of gate contact nodes of the fusecell instances, the pre-decoded input address signals each being coupled to the enable node of a separate fusecell instance.

8. A device for sampling a state of a fuse and latching a signal indicating the state, comprising:
an internal signal node coupling to an output of an inverter and to a gate contact of a first transistor, a source contact of the first transistor coupling to the chip supply voltage, a drain contact of the first transistor coupling to a control node, the control node coupling to an input of the inverter, the control node coupling to a first contact of a fuse, a second contact of the fuse coupling to the ground supply voltage, the control node coupling to a drain contact of a second transistor, a gate contact of the second transistor coupling to an input read signal, a source contact of the second transistor coupling to a drain contact of a third transistor, a gate contact of the third transistor coupled to the ground supply voltage, and a source contact of the third transistor coupled to the chip supply voltage.

9. The device of claim 8, with means including an isolation transistor for:
a. coupling an output node to the internal signal node when an enable signal is logically active, and
b. decoupling the output node from the internal signal node and placing the output node in a high impedance state when the enable signal is logically inactive.
